(19) United States
(12) Patent Application Publication
(10) Pub. No.: US 2016/0214288 A1
(43) Pub. Date: Jul. 28, 2016

(54) MOULDING OF REINFORCED PRODUCTS

(71) Applicant: Colin Leslie Hearl WOOD, Bournemouth, Hampshire (GB)

(72) Inventor: Colin Leslie Hearl Wood, Bournemouth, Hampshire (GB)

(21) Appl. No.: 15/026,617

(22) PCT Filed: Oct. 2, 2014
(86) PCT No.: PCT/GB2014/052989

§ 371 Date: Apr. 1, 2016

(30) Foreign Application Priority Data
Oct. 2, 2013 (GB) 1317465.1
Oct. 22, 2013 (GB) 1318680.4

(51) Int. Cl. B29C 45/14; B29C 45/00

(52) U.S. Cl. CPC B29C 45/14475; B29C 45/0081; B29C 45/14631; B29K 2105/0809

(57) ABSTRACT

A method of forming a moulded product of fibre reinforced body material comprises the steps of: moulding a support that defines openings therein such that reinforcing fibres extend across the openings and into the support; and moulding body material around the reinforcing fibres in the openings.

The present invention relates to the moulding of fibre reinforced products, for example by injection, vacuum, over moulding, extrusion or other moulding methods.

Traditional fibre reinforced products have been made by manual lay-up in an open mould. This is labour intensive. It is used for boats and specialist automotive panels, for instance.

It is known to place reinforcement fabric in an injection mould, close the mould and inject around the enclosed fabric. This can be achieved by robotic placement of the fabric, but tends to involve a considerable amount of expensive equipment. This equipment can limit cycle times.

It is also known to injection mould a cage or the like around an area of fabric, captivating its edges, for production of filters for instance.

It is also known to injection mould polymer having randomly incorporated short fibre reinforcement.

The object of the present invention is to provide an improved method of moulding of fibre reinforced products.

According to the invention there is provided a method of forming a moulded product of fibre reinforced body material comprising the steps of:

moulding a pre-form support that defines openings therein wherein reinforcing fibres extends across the openings and into the support; and
moulding body material around the reinforcing fibres in the openings.

The fibres may be in the form of a fabric. For example they may be woven or matted together, or bonded together. Alternatively they may be simply overlain or lain adjacent to or near each other.

The support may comprise a plurality of sections which are movable relative to each other. The method may comprise positioning the sections relative to each other before the moulding of the body material.

The support may comprise a hinge, or of course a plurality of hinges, arranged to join the sections together so that the support can be folded at the hinge. The support may be folded at the hinge prior to the moulding of the body material. The hinges may be formed of flexible material arranged to flex to allow relative movement of the sections relative to each other. The hinges may be formed at least in part by fibres, and/or they may be formed at least in part by moulded plastics material. For example the reinforcing fibres may extend between the sections so as at least partly to form the hinge. The step of moulding the support may include moulding material so as at least partly to form the hinge. This may be done as the support is being moulded, or as a separate moulding step after the support has been formed. The step of moulding material to at least partly form the hinge may comprise moulding material over a part of the reinforcing fibres to form the hinge.

The sections may comprise locating means arranged to locate them in a desired relative position, relative to each other. The locating means may comprise a part of the reinforcing fibres, which may be arranged, for example, to become taut when the desired position is reached. In addition, or alternatively, the locating means may comprise stop surfaces on the sections arranged to abut against one another to locate the sections. Alternatively or in addition the locating means may comprise clips, which may for example be moulded integrally as part of the individual sections, or bonded or otherwise attached to them.

The support may comprise fibre support means, such as pins or bars, and the method may comprise supporting further reinforcing fibres on the support means prior to moulding the body material. The further reinforcing fibres may be wrapped around the support when the sections are positioned relative to each other.

Normally the pre-form moulding step and the secondary moulding step, which will often be an over-moulding step, will be carried out in two different moulds. However it can be envisaged that the two steps can be carried out in the same mould. For example component pieces of mould parts may be in an advanced position in the first step and a drawn back or exchanged position in the second step whereby injection moulded material permeates the reinforcing fibres only during the second step.

The support may comprise a plurality of sections or limbs, and the limbs or sections may surround or define the openings. Normally the limbs will be joined together as a skeleton, but they can be partially or totally structural in the finished product, i.e. moulded into or around the finished product.

Whilst the purpose of the pre-form is to locate the reinforcing fibres in the mould for the second moulding step, it is envisaged that the pre-form need not have the same shape as the second or main mould. This can be achieved in two ways:
1. For less pronounced shaping, the pre-form can be deformed, typically by bending certain of the limbs, on positioning in the main mould. This enables for instance the pre-form to be made with the fibres flat in the pre-form mould and then deformed to the shape of an automotive panel for instance on loading into the main mould. In this case, it is likely that stresses in the pre-form caused by bending will be relieved on secondary moulding. Nevertheless some residual stress may remain;
2. For more pronounced shaping the pre-form can be provided with one or more bend lines, typically as living hinge lines, i.e. regions of flexible material which form hinges by flexing. These may be formed, for example, by constriction of the thickness of the support, for example of certain of the limbs of the support, at certain places. Thus, for instance, a margin of the pre-form can be bent out of its general plane on placement in the main mould to form a flange, which might be useful around an automotive panel for instance. The reinforcing fibres may extend through the living hinges.

Additional reinforcing fibres can be wound around the pre-form particularly where it has been bent into a shape different from its original shape, but also where it has been hinged to shape. For instance the pre-form for a five or other multiple-sided casing, with a separate closure, will typically have multiple portions hinged together for folding into a many sided shape. This shape can be wrapped around with further reinforcing fabric before being place in the main or secondary mould. A closure can be similarly moulded.

The pre-form can be provided with stops and/or clips for limiting its bending and/or holding it in its folded shape.

Inserts can be included in the product, such as threaded bosses for bolts, which may be used for example to secure the lid. Whilst these could be placed in the main mould only, normally these will be placed in the pre-form mould and moulded into the pre-form.

Other inserts can be provided, such as seats for bearings and oil seals, for instance where the casing is a gearbox casing. For example the inserts may each comprise a fixing member as described in international patent application PCT/GB2014/052376.

The reinforcing fibres may be formed into a fabric, which can take a variety of forms. Whilst randomly oriented non-woven fabric is possible; normally aligned fibre fabric will be used, either as woven fabric or crimp free fabric in which the fibres are stitched or attached in any other suitable way such as sprayed and bonded with dissolvable ‘Silane’ binder in arrayed bundles set at angles to each other in layers.

Specialist fabrics such as those described above may have webs woven at various angles to each other, and those held together by elastomeric stitching allow laying up on curved surfaces.

The fabric may be of glass fibre or carbon fibre.

The body material will typically be a plastics material, which will normally be a thermoplastic or thermoset material. These can be filled with short milled fibres in the normally way in addition to being used with the reinforced fibre introduced into the product via the pre-form.

The reinforcing fibres may be held in tension during the moulding of the support. The support may moulded around the fibre so that the moulded support holds them in tension. The support may be moulded in a mould tool that comprises tensioning means arranged to tension the fibres on closing of the mould tool.

The support may be moulded in a tool having a movable part and the method comprises placing the fibre in the tool, and moving said part to move the fibre prior to moulding the support. For example the moving part may be arranged to compress the fibre, or to form an aperture or space through the fibre in which to locate an insert.

The second moulding step may be performed using a moulding tool which is arranged to move at least a part of the fibre relative to the support prior to the second moulding step, for example to shape or locate the fibres prior to overmoulding.

The invention further provides a method of forming a moulded product of fibre reinforced body material comprising the steps of: providing a moulded support having two sections joined to each other by at least one hinge and a reinforcing fibre extending between the two sections, folding the sections relative to each other thereby to tension the reinforcing fibre, and moulding body material around the reinforcing fibres.

The support may comprise spacers arranged to space the reinforcing material from the surface of the support so that the body material can completely enclose a length of the reinforcing fibre.

Two of the spacers may be arranged to move away from each other on folding of the sections thereby to tension the fibre.

The invention further provides a method of forming a moulded product of fibre reinforced body material comprising the steps of: providing a moulded support and reinforcing fibres supported by the support such that at least a part of each of the fibres is clear of the support, and moulding body material around the reinforcing fibres so that the body material encloses said part.

The support may be arranged to support the fibres at either side of said parts. For example parts of the fibres may be moulded into the support at either side of said parts. The fibres may be held in tension during the moulding of the body material.

It will be appreciated that each of the steps can be performed in an automated manner by robotic manipulation and automated tooling.

Therefore the present invention further provides a manufacturing system for manufacturing a moulded product according to the invention, the system comprising a pre-mould station in which the fibres are robotically placed in a pre-moulding tool, which can then be closed and the pre-mould formed, a shaping station arranged to move the parts of the pre-mould into the desired position, and a second moulding station in which the second moulding stage is performed. The system may be arranged to perform any one or more of the steps of the method of the invention.

The method may further comprise any one or more steps, in any workable combination, of the embodiments of the invention that will now be described by way of example only with reference to the accompanying drawings, in which:

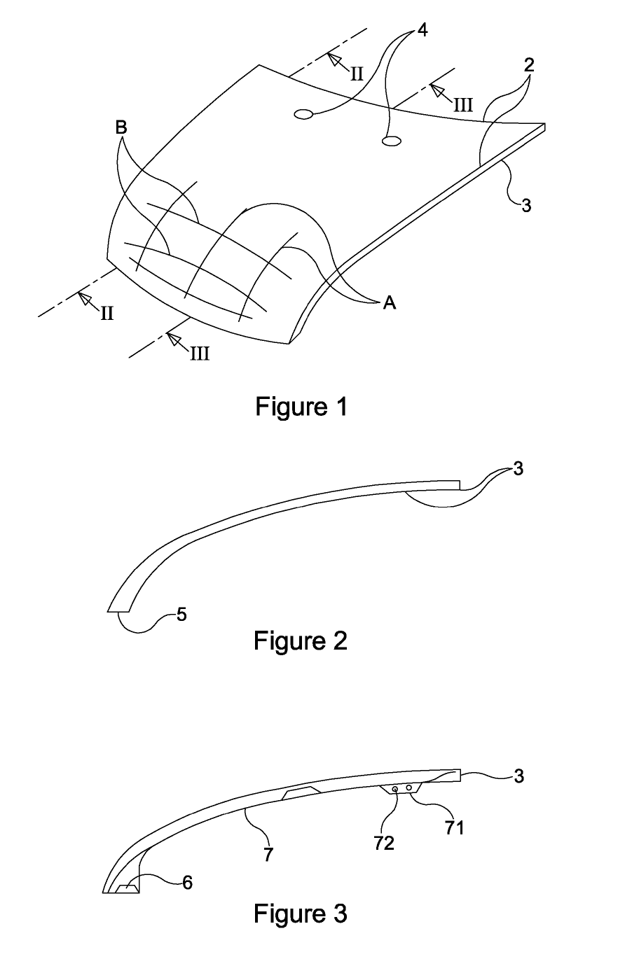

FIG. 1 is a perspective view of an automotive bonnet formed in accordance with an embodiment of the invention;

FIG. 2 is a cross-sectional view on the line II-II of the bonnet of FIG. 1;

FIG. 3 is a cross-sectional view on the line of the bonnet of FIG. 1;

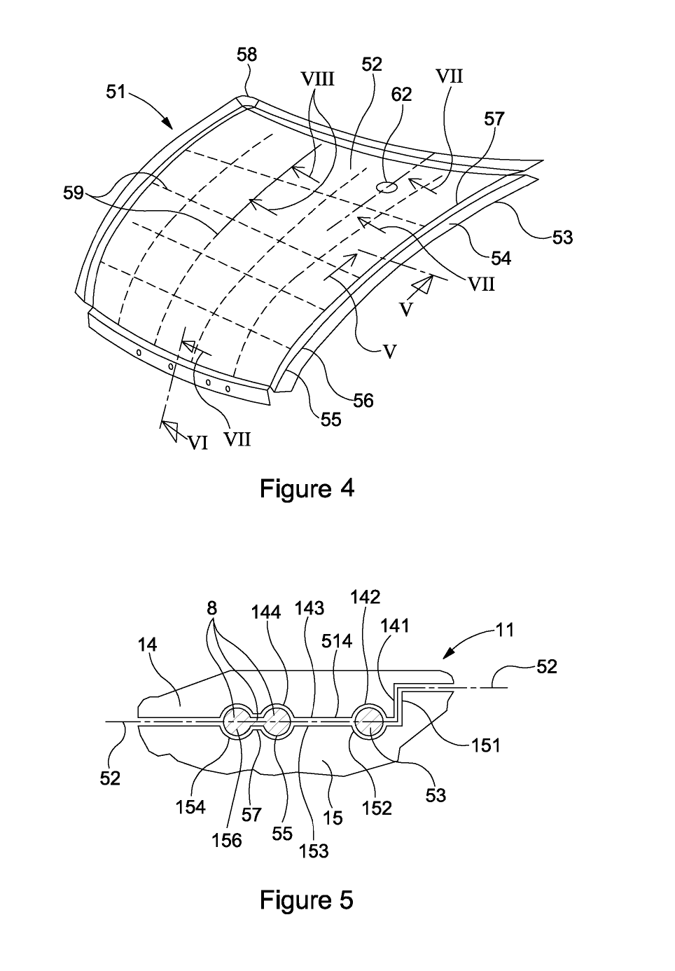

FIG. 4 is a view similar to FIG. 1 of the pre-form for the bonnet of FIG. 1;

FIG. 5 is a scrap view on the line V-V of a side flange pre-form portion of the pre-form of FIG. 4 formed in a mould therefor;

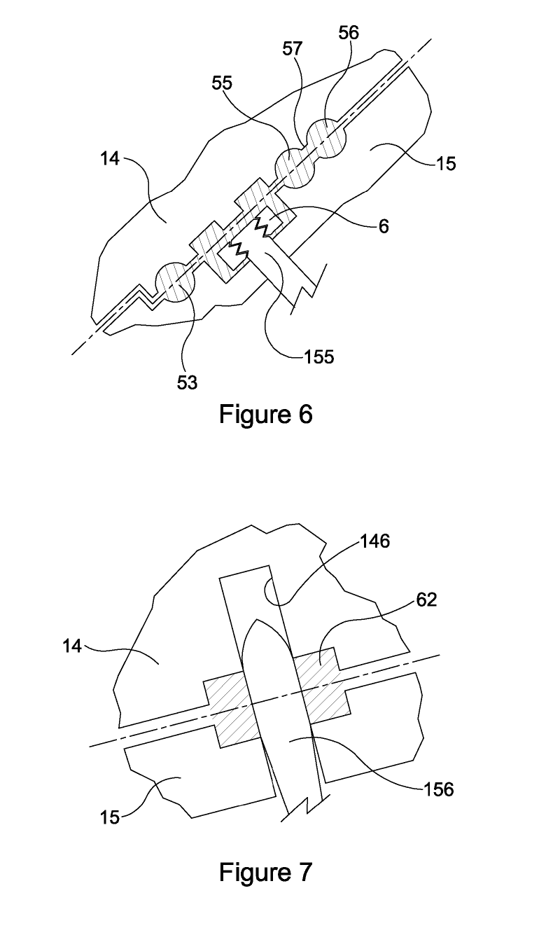

FIG. 6 is a similar scrap view on the line VI-VI of a front flange pre-form portion;

FIG. 7 is a similar scrap view on the line VII-VII of a washer jet aperture;

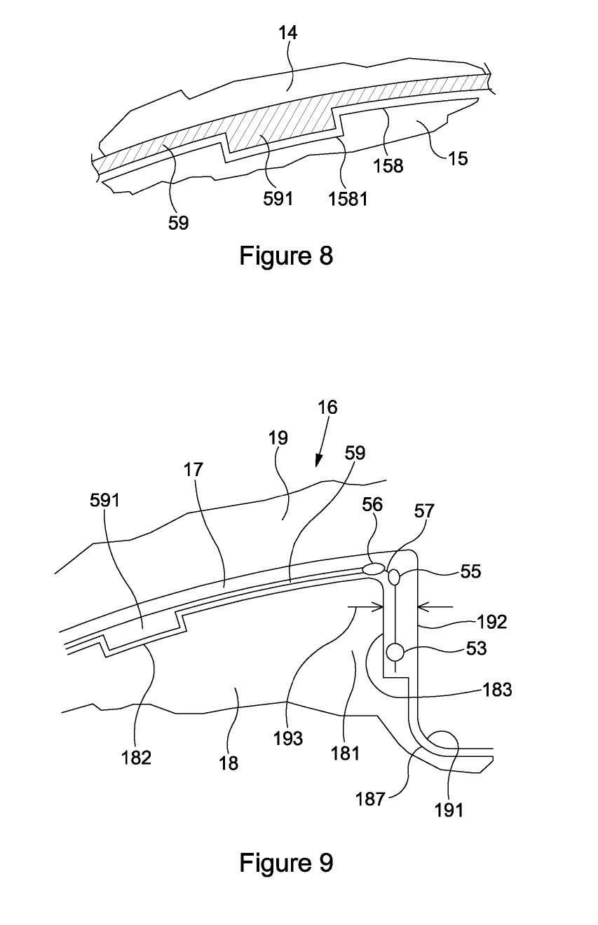

FIG. 8 is a similar scrap view on the line VIII-VIII of a pre-form limb and extension;

FIG. 9 is a scrap view analogous to FIG. 8 and extending to the back flange of the bonnet pre-form in a secondary moulding tool prior to secondary moulding;

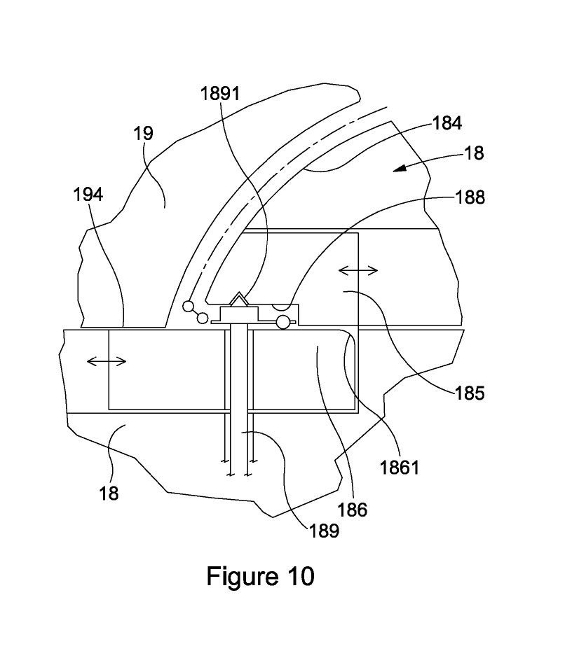

FIG. 10 is a scrap view analogous to FIG. 6 and showing a front flange of the bonnet pre-form in a secondary moulding tool prior to secondary moulding;

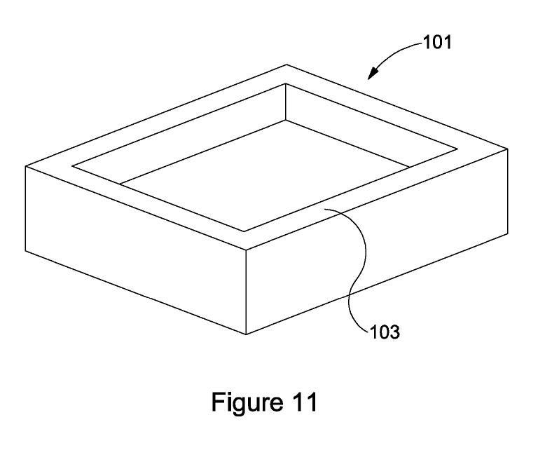

FIG. 11 is a perspective view of a flanged base formed in accordance with a further embodiment of the invention;

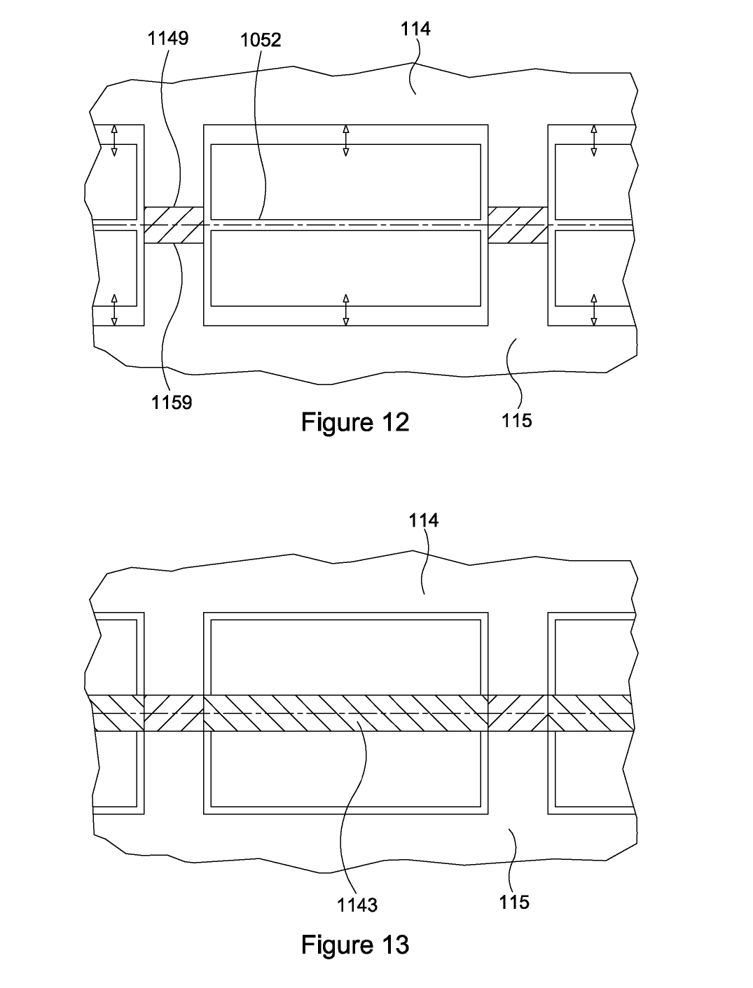

FIG. 12 is a scrap cross-sectional view centrally of the flanged base of FIG. 11 during pre-form moulding in its mould;

FIG. 13 is a scrap cross sectional view of the flanged base at the same position as FIG. 12 during secondary moulding in the same tool;

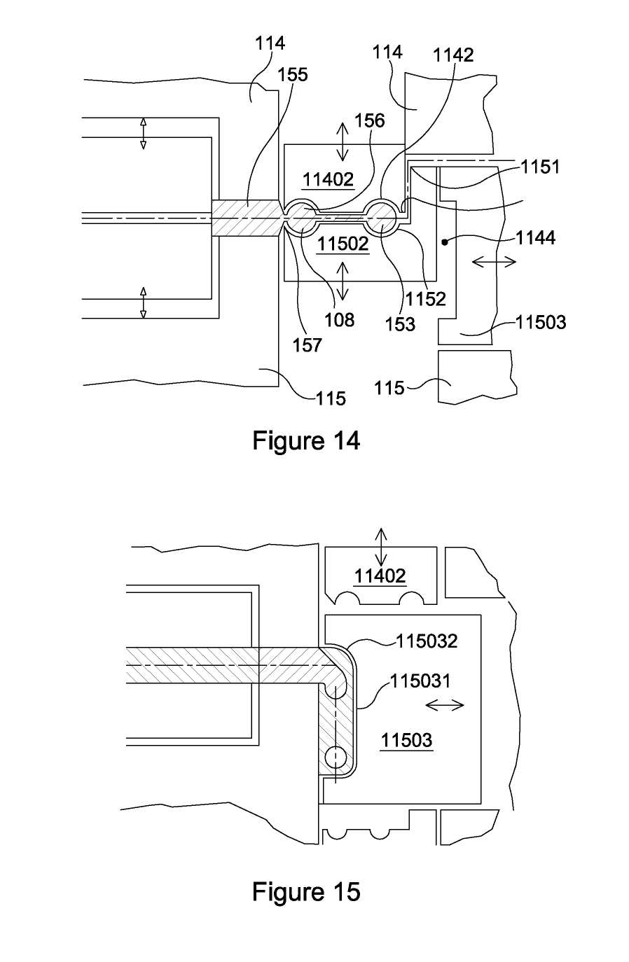

FIG. 14 is a scrap cross-sectional view of an edge of the base and of one of its flanges during pre-form moulding in its mould;

FIG. 15 is a scrap cross sectional view of the edge of the base and of the one flange at the same position as FIG. 12 during secondary moulding in the same tool;

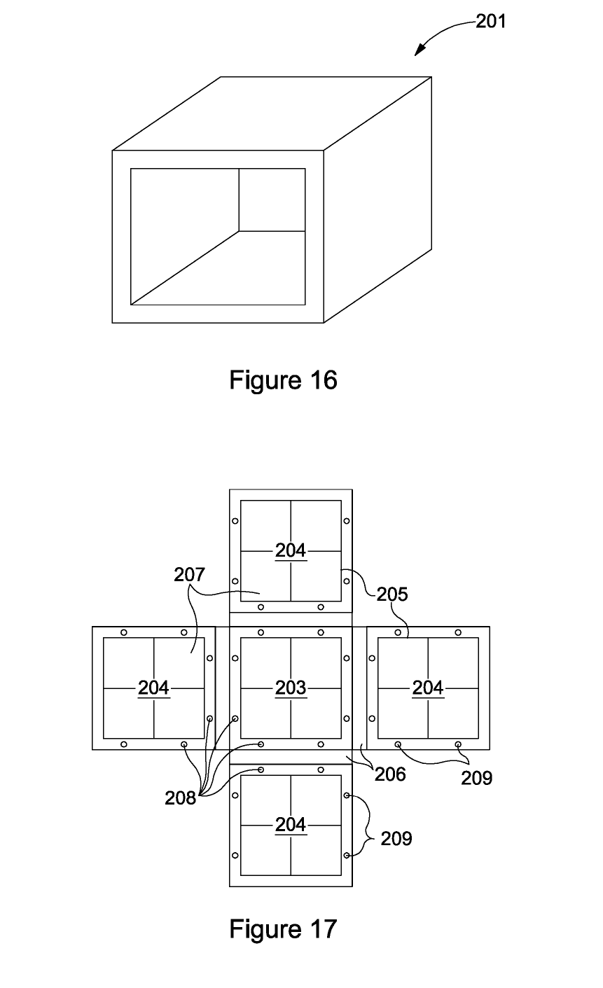

FIG. 16 is a perspective view of a casing formed in accordance with a further embodiment of the invention;

FIG. 17 is a plan view of a pre-form for the casing of FIG. 16;

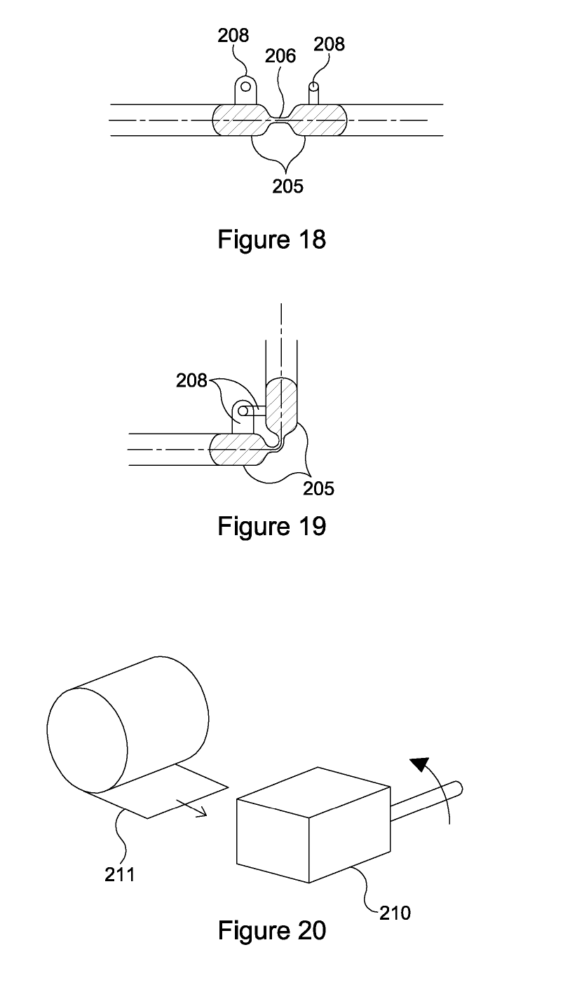

FIG. 18 is a scrap cross-sectional view of one of the hinges in the pre-form as moulded;

FIG. 19 is a scrap cross-sectional view of the living hinge shown in FIG. 18, folded for secondary moulding;

FIG. 20 is a perspective view of a mandrel for receiving the pre-form of FIG. 17 as folded for wrapping;

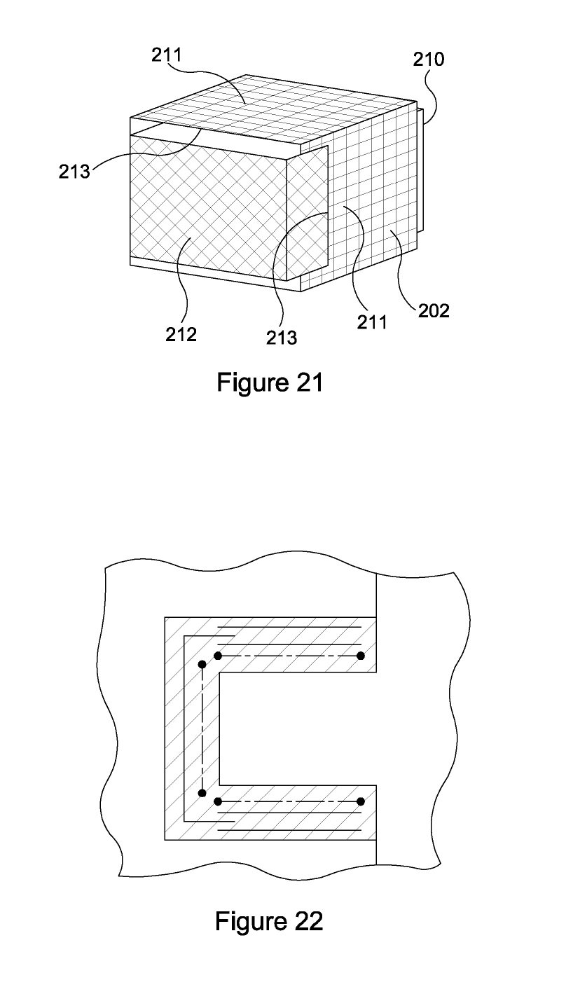

FIG. 21 is a similar perspective view of the pre-form after wrapping;

FIG. 22 is a cross-sectional view of the pre-form secondarily moulded to form a casing;

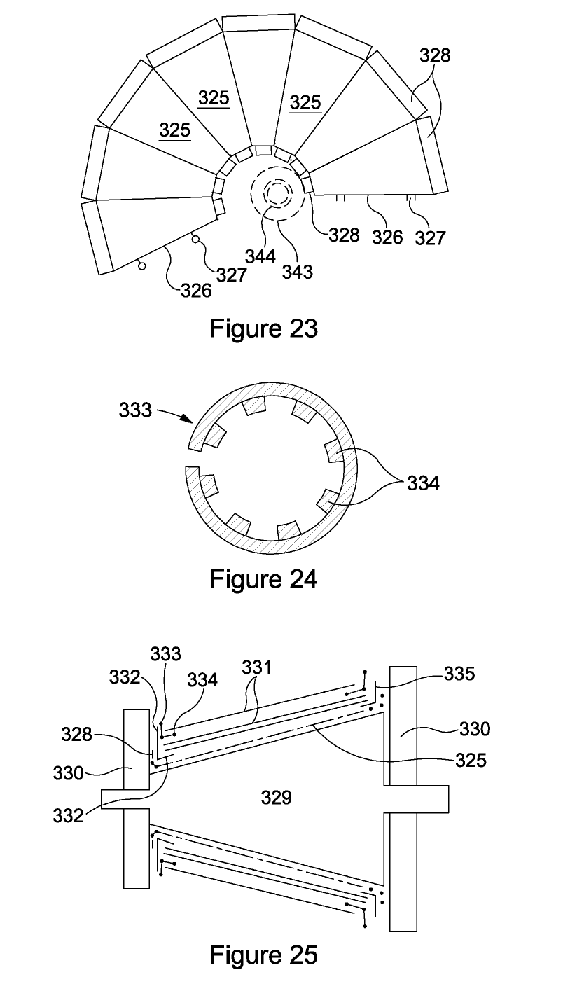

FIG. 23 is a plan view of a pre-form for a tapered casing according to a further embodiment of the invention;

FIG. 24 is a plan view of reinforcing fabric rings for use with the pre-form of FIG. 23;

FIG. 25 is a cross-sectional view of the pre-form of FIG. 23 being prepared on a mandrel for secondary moulding;

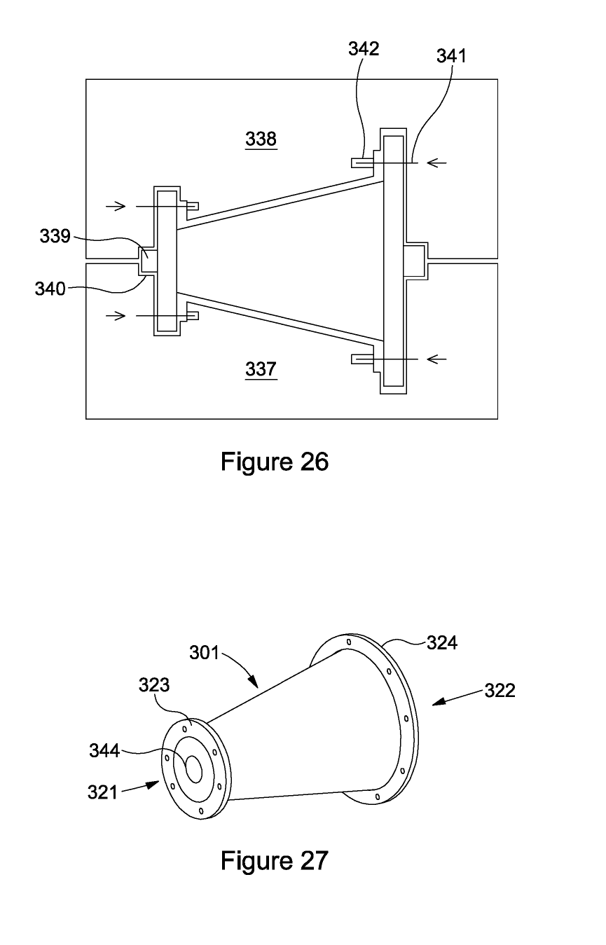

FIG. 26 is a cross-sectional view similar to FIG. 25 of the prepared pre-form in a mould for secondary moulding;

FIG. 27 is a perspective view of the tapered casing after moulding as in FIG. 26;

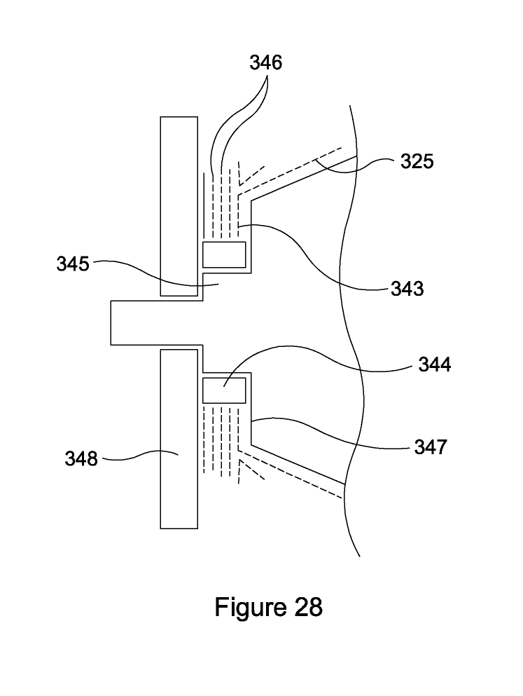

FIG. 28 is a scrap view similar to FIG. 25 showing a bearing ring being incorporated with a pre-form;

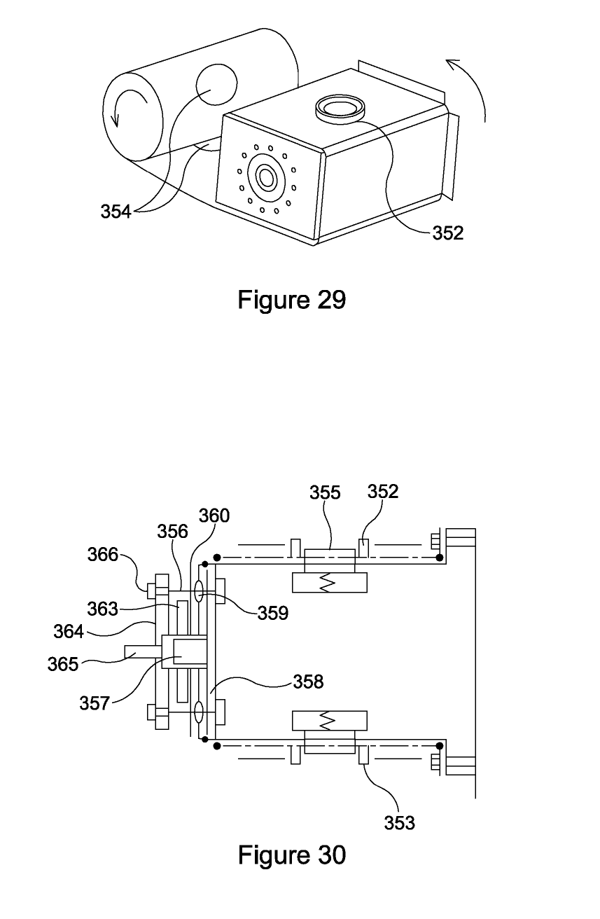

FIG. 29 is a view similar to FIG. 20 of a modified pre-form being wrapped;

FIG. 30 is a cross-sectional view of the pre-form of FIG. 29 being further prepared for secondary moulding;

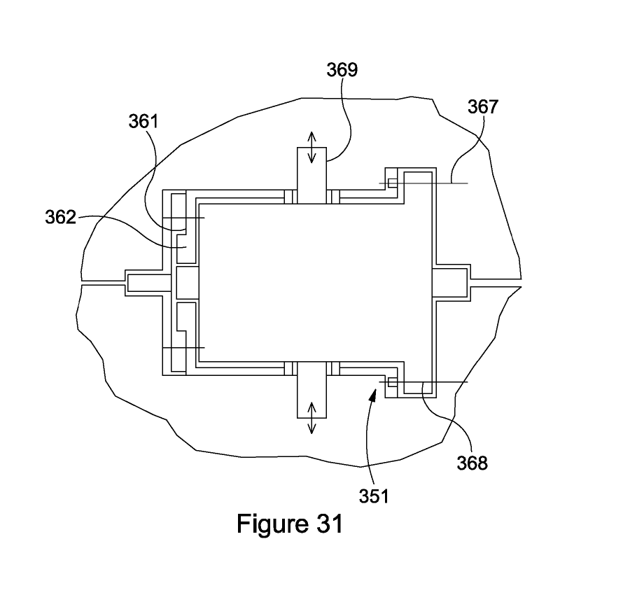

FIG. 31 is a similar view of the prepared pre-form of FIG. 30 in a mould during secondary moulding;

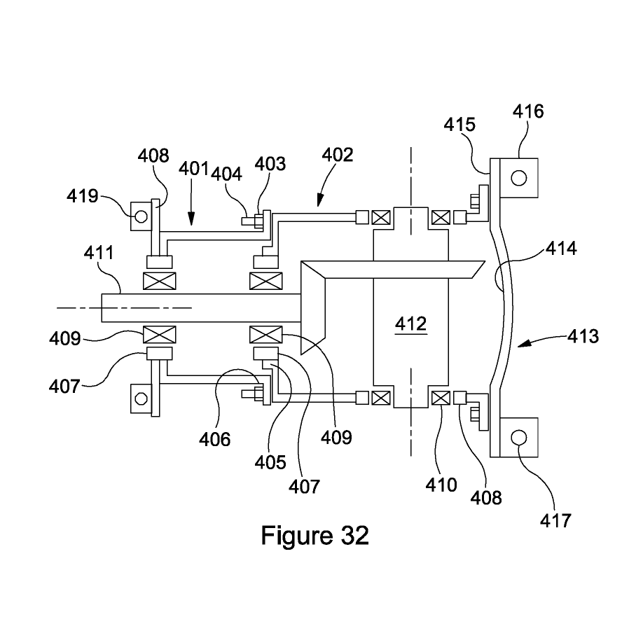

FIG. 32 is a cross-sectional view of a differential casing assembled from four products moulded in accordance with the invention;

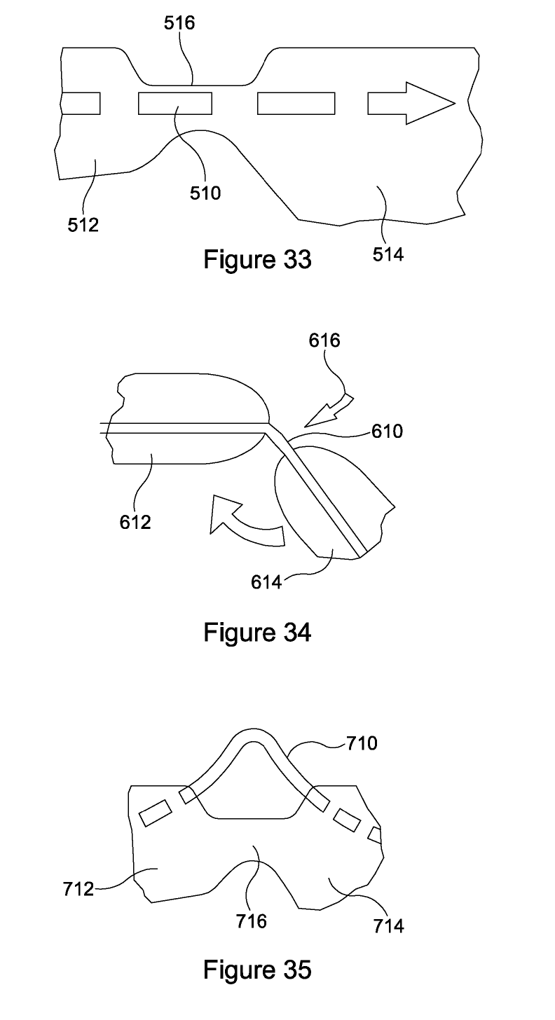

FIG. 33 is a scrap section through a hinge in a pre-form for a moulded product according to a further embodiment of the invention;

FIG. 34 is a scrap section through a hinge in a pre-form for a moulded product according to a further embodiment of the invention;

FIG. 35 is a scrap section through a hinge in a pre-form for a moulded product according to a further embodiment of the invention;

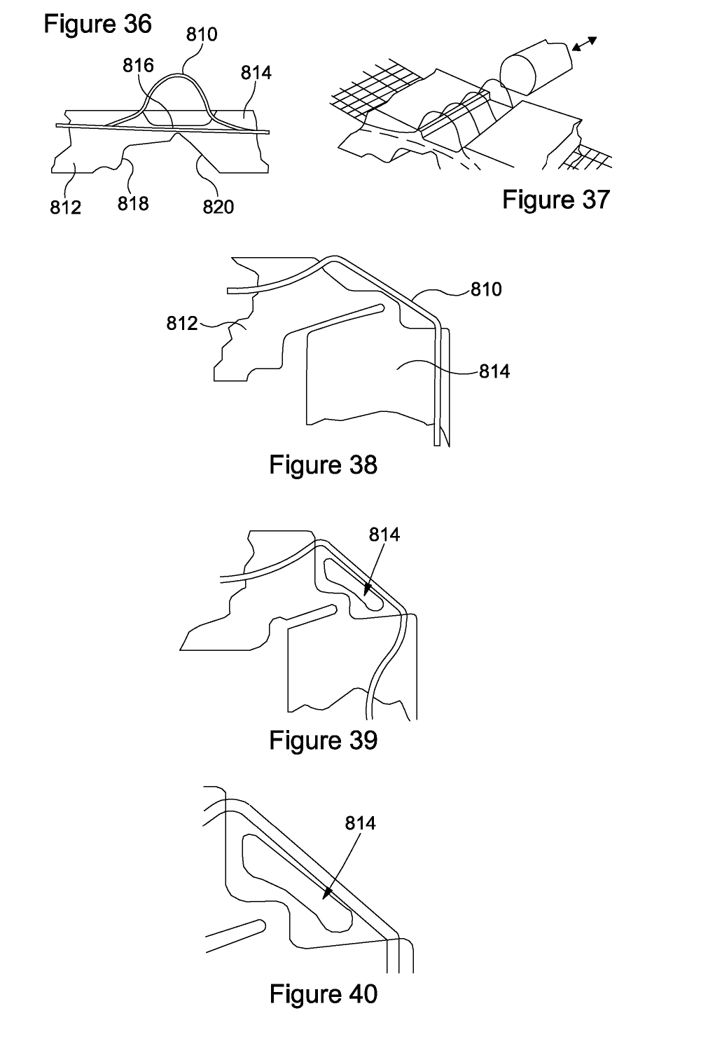

FIG. 36 is a scrap section through a hinge in a pre-form for a moulded product according to a further embodiment of the invention;

FIG. 37 shows the formation of the hinge of FIG. 36;

FIG. 38 is a scrap section of the hinge of FIG. 36 in a folded condition;

FIG. 39 is a scrap section through a hinge in a pre-form for a moulded product according to a further embodiment of the invention;

FIG. 40 is an enlargement of part of FIG. 39;

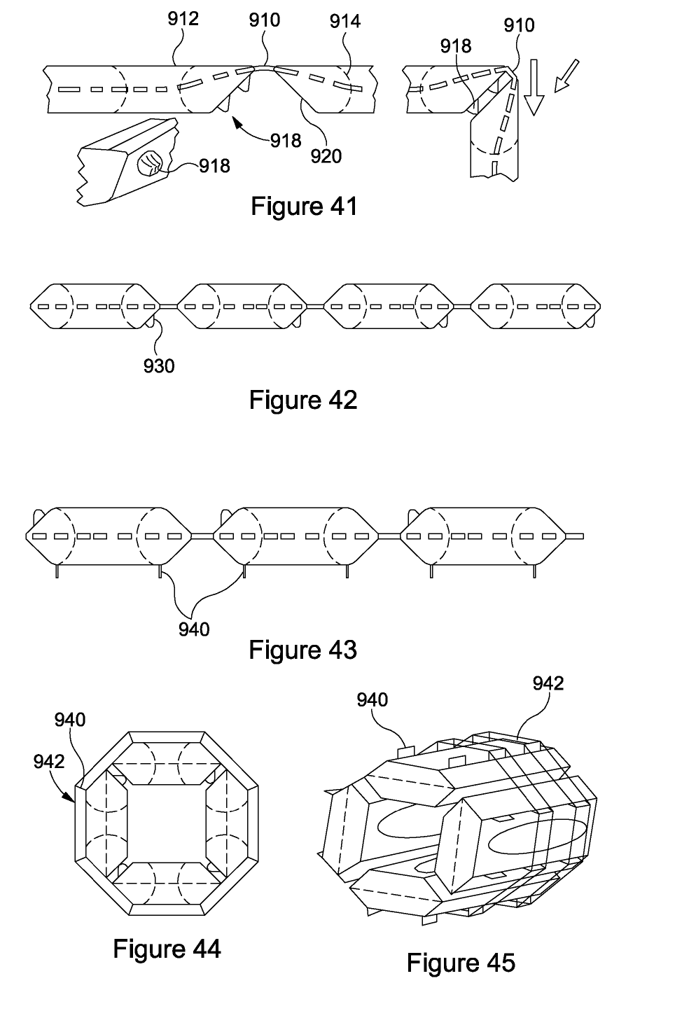

FIG. 41 is a section through a pre-form for a moulded product according to a further embodiment of the invention;

FIG. 42 is a section through a pre-form for a moulded product according to a further embodiment of the invention;

FIG. 43 is a section through a pre-form for a moulded product according to a further embodiment of the invention;

FIG. 44 shows the pre-form of FIG. 43 with reinforcing fibres wound on it;

FIG. 45 is a perspective view of the pre-form of FIG. 44;

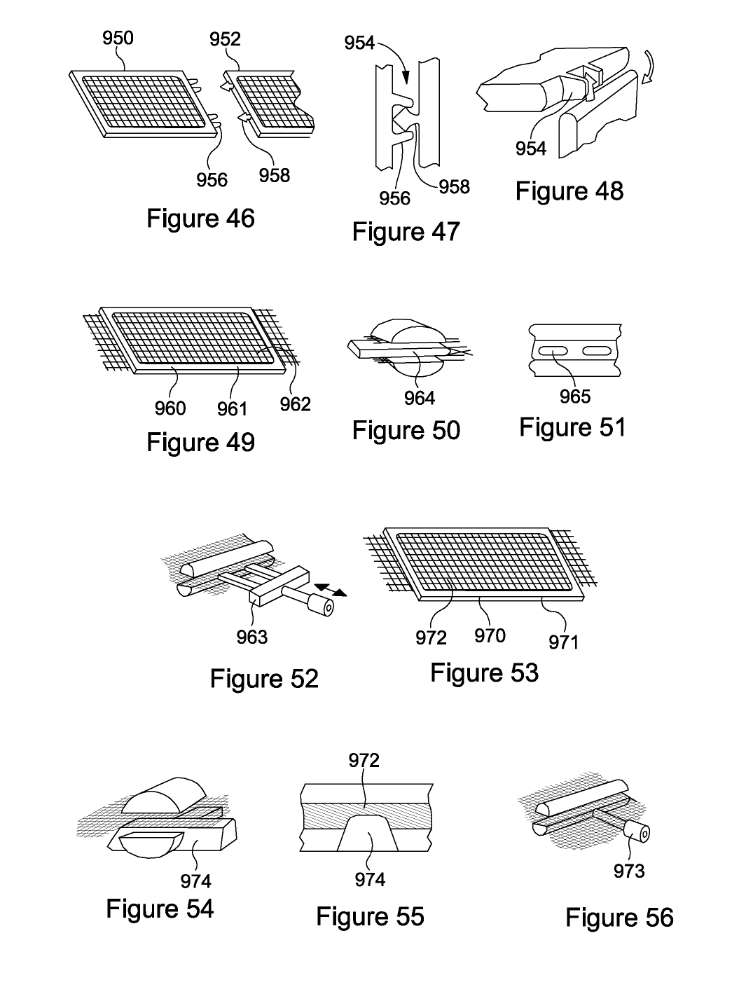

FIG. 46 is a perspective view of part of a pre-form for a moulded product according to a further embodiment of the invention;

FIG. 47 is a section through a hinge of the pre-form of FIG. 46;

FIG. 48 is a perspective view of the hinge of FIG. 47 in a folded condition;

FIG. 49 is a perspective view of a pre-mould support according to a further embodiment of the invention;

FIG. 50 is a sectional view of part of the support of FIG. 49 during moulding;

FIG. 51 is a cross section through part of the support of FIG. 49 during moulding;

FIG. 52 is a perspective view showing part of the mould tool used to form the support of FIG. 49;

FIG. 53 is a perspective view of a pre-mould support according to a further embodiment of the invention;

FIG. 54 is a sectional view of part of the support of FIG. 53 during moulding;

FIG. 55 is a cross section through part of the support of FIG. 53 during moulding;

FIG. 56 is a perspective view showing part of the mould tool used to form the support of FIG. 53.

Referring to FIGS. 1 to 10 of the drawings, there is shown an automotive exterior bonnet panel 1, injection moulded from engineering grade thermoset polymer with woven mat glass fibre reinforcement. The entire bonnet has many features and for the purposes of disclosing this invention, all of these features will be described whereby the skilled reader will be able to produce an entire bonnet, though it will be appreciated that in other embodiments one or more of these features may not be present.

The panel has curvature in two orthogonal planes indicated by the lines A, B. For stiffening of the side and rear edges 2 of the bonnet panel, a down-turned flange 3 is provided. For mounting of washer jets, plain apertures 4 are provided. For mounting a bonnet latch and safety catch (neither shown as such) a front in-turned flange 5 is provided with threaded inserts 6. For stiffening the bonnet generally, an inner skin 7 is bonded to the under-surface of the exterior panel 1. The inner skin is produced in a manner similar to the exterior panel and insofar as its features are simpler, the production of the more complex outer panel only will be described. It will of course be appreciated that in other embodiments it is not necessary to have an inner skin because instead it is possible to ‘sandwich’ a light weight solid or closed cell foam core between two layers of the fabric at preform stage or to over-wind additional fabric onto the pre-form before placing it into the second stage mould prior to over moulding in a second tool.

The degree of curvature is such that the bonnet can be formed with a continuous sheet of reinforcement material, albeit of the type having orthogonally or unidirectional or other aligned fibres stitched, laid, woven or bonded into a sheet. Such a crimp-less sheet drapes easily.

A pre-form 51, (see FIG. 4), is produced in a two part mould 11 (see FIG. 5) having an upper, moving mould part 14 and a lower fixed mould part 15. It is provided in association with means (not shown) for feeding the reinforcing fabric across the lower fixed part 15. In the drawings, the mould is not shown in its entirety, but in a number of detailed, scrap, cross-sectional views. It should be noted that the upper mould part 14 corresponds to the upper, outer surface of the finished exterior panel and is therefore concave at its mould cavity, whilst the lower mould part 15 is convex.

Apart from curvature, the mould parts 14, 15 have a number of features which will now be described.

Around the periphery of the mould cavity, the mould parts 14, 15 are provided with complementary shear edges 141,151 for cutting the reinforcing fabric 52 to the approximate shape of the finished product when mould is closed (other methods of cutting the fabric will be described further below).

Along the cut edges of the fabric, along the edges of the flanges 3, 5, or at least along the edges of pre-forms therefor, are grooves 142, 152 in the mould tools for forming edge limbs or sections 53 of the pre-form flanges.

Set in from the grooves 142, 152 are lands 143, 153, which are spaced apart from each other when the mould tool is closed by the compressed thickness of the reinforcing fabric, so that, when the mould tool is closed the lands can grip the reinforcing fabric at its extent 54 in the pre-form flanges.

Set in again are hinged limb forming grooves 144, 154. These are complementary to each other and when closed form a cavity 8 which is generally 8-shaped in cross section as seen in FIG. 5, extending at the finished extent of the bonnet. Their purpose is pre-moulding of paired limbs or support sections 55, 56 with an intervening living hinge 57 preparatory. The hinge allows the fabric to be turned down/in for the flanges 3, 5. Ducts for feeding polymer to the grooves 144, 154 on injection are not shown. The skilled addressee will be familiar with the design of mould tooling in this respect.

At the corners between the pre-forms for the flanges, the shear edges cut the fabric to a radiused gusset 58 which provides reinforcement of the flanges to each other at the corners.

At arrayed positions in the lower mould part, corresponding to the front flange positions suitable for the bonnet latch and safety catch, threaded pins 155 for receiving the threaded inserts are provided (see FIG. 6). The inserts are mounted on the pins in the mould prior to moulding. The pins 155 are drivable to release the pre-mould with the inserts on opening of the mould tool. The mould parts have recesses for formation of lugs of pre-mould polymer to hold the threaded inserts 6.

In an alternative arrangement, instead of the threaded inserts, threaded pins can be moulded into the panel. These can comprise a flat or shaped base and threaded stud as described in our international patent application No. PCT/GB2014/052376. These fixings can have a large skirt design to sit on or under, or to be interleaved between, the preform and wound on fabric. Because this type of fixing can have a large surface area within the moulding it can be used to ‘eject’ the moulding. This would eliminate the circular impression associated with ejector pins that require post mould surface preparation if on the exterior surface.

Referring to FIG. 7, at the positions of the washer jets, the upper mould part 14 has bores 146 into which pins 156 extending from the lower mould part 15. On closure of the pre-form mould the pins are driven through the reinforcing fabric and the injected pre-form material forms the apertures 4 in the pre-form rings 62. The sharp pin 156 will tend to push the fabric to the top face of the cavity 146. In order to keep the fabric in the same plain at the same level throughout the moulding it is an option to have a retractable sleeve coming from the upper side of the tool, for example around the edge of the bore 146, so that it meets the fabric half way and holds it there as the pin 156 initially pierces through. Then the sleeve retracts allowing the pin 156 to move further through the fabric to enlarge the hole it forms.

In an orthogonal array across the bonnet, a series of shallow depressions 158 is provided in the lower mould part for forming limbs or support sections 59 to support the fabric on removal of the pre-form from the mould 11. The limbs have a number of extensions 591 for locating the pre-mould in the main mould at positions which will be hidden by the inner skin 7.

In a modification to this embodiment, the complementary edges 141, 151 are not sharp enough to cut the fibres, but rather are used to tension the fibres prior to moulding of the pre-mould. To achieve this, the fibres are laid in place and held in tension by a tensioning device which is outside the edge of the mould, for example using the tool that lays them. Then, as the two halves of the mould are brought together, the edges 141, 151 push two parts of the fibres out of their initial position, which is in a straight line, into a curved or bent path, thereby increasing the tension in the fibres. When the pre-mould is moulded around the fibres, the pre-mould then holds the fibres in tension, so that the fibres exert a compressive force on the frame of the pre-mould.

Referring to FIG. 9, the main mould 16 has a cavity 17 shaped for final shaping of the exterior panel of the bonnet. The cavity is formed between a fixed lower part 18 which is convex for receiving the pre-form and a moving, concave, upper part 19. The upper part is plain and polished for a gloss finish to the moulding. The lower part has a central, raised portion 181 having array of grooves 182 for receiving the extensions 591, whereby the pre-mould is located on the lower mould part at a height to position the reinforcing fabric 52 at mid-height in the cavity away from the grooves, with the living hinges 57 at the edges of the raised portion of the lower mould part. The side and back edge flange pre-forms can hinge down to lie against side and back sides 183 of the raised portion. As shown in FIG. 10, the front side 184 of the raised portion is effectively under cut, in that a collapsible core 185 is provided, under which the front flange pre-form can hinged. An oppositely movable collapsible core 186 is provided in the front of the raised portion at a level to support the collapsible core 185 when the mould is closed with the interposition of the front flange.

Operation of the two mould tools 11, 16, in respective injection moulding machines will now be described.

The pre-form tool 11 is opened and reinforcing fabric drawn between the mould parts. The tool is closed cutting the reinforcing fabric to shape. The resultant cavity is merely that for the sections or limbs 53, 55, 56 of the pre-moulded support, with hinges 57. Together these form a support frame supporting the fabric. The pre-form is then either
(1) revealed by opening the mould and leaving the pre-mould in half allowing over moulding on one side and through fabric; or
(2) jacked up slightly in one side of the moulding tool, but not taken out of the tooling, to over mould on both sides,
(These two options are possible for one- or two-sided shapes or bucket type shapes but not a hollow with complex undercuts etc.); or
(3) removed from the pre-form mould and placed on the raised portion of the main mould.

The injected polymer of the pre-form support frame may be a thermoset one, but where the polymer covers the reinforcing fabric to form the hinges, it must be one that does not set so hard as to prevent the hinges from bending. Alternatively, if the polymer is kept away from the parts of the fabric that form the hinges, the thermoset or thermoplastic first stage skeleton can be stiff and hard after moulding. In this case it is the fabric that is still soft and flexible that allows hinging unless a plastic hinge is made using a different highly flexible polymer.

The main mould is open and the pre-form placed in position. It is not expected that the side and edge flanges will drop down at least completely under their own weight, not least because of the curvature of the preform. The moving mould tool has curved edges 191 to extending portions 192 that are spaced from the sides of 183 of the raised portion. The curved edges 191 slide over the flange pre-forms and then mate with corresponding curves 187 (see FIG. 9) in the fixed mould part for mould closure. The gap 193 between the sides of the raised portion and the extending portions provide for formation of the side and back flanges 3, 5. It is the action of the curved edges 191 which moves the flange pre-forms into the gaps 193. At the corners, the radiused gussets 58 are folded into position between the side flange gaps and the back flange gap.

At the front, the collapsible core 185 has a rebate 188 set above the under-face 194 of the movable mould part. The mould tool is first closed and then the collapsible core 185 is advanced; this has the effect of ensuring the front flange pre-form extends generally downwards. Advancing of the collapsible core 186, with a curved leading edge 1861 hinges the flange pre-form under the withdrawable tongue. This involves certain foreshortening of the front limb 53, which may be shaped to accommodate this. To positively the inserts 6, threaded pins 189 are advanced through the collapsible core 186 and engage in the inserts and seats 1891 (see FIG. 10) in the collapsible core 185.

Across the main extent of the mould, the reinforcing fabric extends in the mould cavity 17. It is held off the lower mould surface by the support frame limbs 59. The tooling and the pre-form is now arranged for injection of thermoset or thermoplastic polymer suitable for the finished exterior bonnet panel. This permeates around the entire pre-form and through the fabric across the main extent of the mould. For removal of the product, the tongues are both withdrawn, allowing the tool to be opened and the product to be ejected from the mould.

The inner skin is produced in an analogous manner of a pre-form and a final moulding. It is simpler and has only two hinged flanges 71, for bonnet hinges, for the attachment of which the flanges are provided with threaded inserts 72.

Other embodiments of the invention will differ from the details described. For instance it can be envisaged that the exterior panel and the inner skin could be produced in the same two mould tool 11, 16—suitably extended—with one or more hinges being provided at the back of the bonnet. The hinge(s) could be living hinge(s) of pre-mould polymer, with the reinforcing fabric extending through or over the hinge(s). Alternatively the hinge(s) could be provided as strip(s) of the fabric left dry, i.e. free of polymer. On removal from the second mould, the liner has adhesive applied and is hinged into position on the inside of the exterior panel. Adhesive can be applied along the hinge(s).

In further modifications to the embodiment described above, where shear edges on the tool are not suitable for cutting the reinforcing fibres, for example if they are of glass, carbon or aramid, other cutting methods can be used, such as ultrasonic cutting, which can be used with a 3 dimensional cutting line, robotic trimming, or cutting shears.

Also in the embodiment shown in FIGS. 11 to 15, the entire moulding process can be performed in a single mould. This is envisaged for production of a product 101 not requiring high-gloss for use as an external panel. For single mould moulding, the moving upper mould part 114 and a lower fixed mould part 115 both have movable elements. These will now be described.

Between the mould depressions 1149, 1159, and provided on both sides of the reinforcement fabric, movable elements 11401, 11501 extend. These are advanced during the primary moulding stage and withdrawn in the secondary stage, locating the reinforcing fibres, which in this case are in the form of a mat 1052, during primary moulding and providing a secondary moulding void 1143 for body material injection on withdrawal of the movable elements.

At the edge of the product, i.e. outwards to the outermost depressions 1149, 1159, movable elements 11402, 11502 are provided for moulding flanges 103. The movable elements 11402, 11502 are a pair, one carried in the movable mould part 114 and the other by the fixed mould part 115. With the outermost of the depressions 1149, 1159, they form extended 8 shaped cavities 108 for a limb/hinge pre-form formation 155, 156, 157. They also have outer depressions 1142, 1152 for a flange edge limb 153, and shear edges 1141, 1151 if the reinforcing fibres can be cut by such edges. These flange pre-form, movable elements are withdrawable substantially in their mould parts as shown in FIG. 15.

Initially outwards in a moulding cycle is positioned an element 11503 movable in the fixed lower mould part 115, at a level below the un-sheared portion of the reinforcing fabric. After pre-form moulding, the movable elements 11402, 11502 are withdrawn, leaving the flange pre-form extending in a void 1144. It may tend to droop under its weight and/or it may be encouraged to droop by withdrawal of the lower movable element 11402 first. The movable element 11503 is initially outwards of the void 1144 and is moved into it. It has a flange depression 115031 with a curve 115032 for radiusing the root of the flange and urging the flange pre-form to hinge down, if it has not already done so by drooping. On abutment of the movable element against the non-movable mould parts, the depression defines the shape of the flange 103 and has the pre-form hinged down in it.

Thus with movable elements all moved from their pre-form moulding position, the secondary polymer can now be injected and/or introduced assisted by pressure and or vacuum.

As described, the product will be of uniform thickness. However features of shape can be introduced as required by suitably forming the mould depressions 1149, 1159 and/or the movable elements 11402, 11502.

Turning on to FIGS. 16 to 22, in contrast to the previous embodiments, which are for the production of essentially thin products with edge flanges, which can be thought of as largely two dimensional, a further embodiment is a fully three dimensional casing. It has an opening, which can be closed by a closure formed as in the first embodiment.

The embodiment is described as a five sided rectangular casing 201. Many different shapes are possible. The pre-form 202 for the casing comprises a central rectangle 203 with four individual rectangles 204 foldable out of the plane of the central rectangle. The method of production of the pre-form 202 is essentially that of the pre-form 51 of FIG. 4, with the central rectangle 203 being equivalent to the panel 1 and the rectangle 204 being equivalent to the pre-forms for the flanges 3, 5. As such the production of the pre-form 202 will not be described in detail.

Each rectangle has peripheral support sections or limbs 205 with flexible hinges, which may be living hinges or fabric hinges 206 connecting the rectangles, and a grid of reinforcing fabric support sections or limbs 207 within the outer peripheral sections, which define a series of openings across which the fabric extends. The fabric therefore is moulded into the frame on either side of the openings, and has a part within each opening which is free and unsupported, and not in contact with the support. Referring to FIGS. 18 and 19, at the hinges, the limbs are formed with co-operating latch formations 208, which limit the hinging movement and snap into engagement with each other to hold the rectangles at right angles to each other when they are hinged to that position as shown in FIG. 19. Further latch formations 209 are formed at the edges of the rectangles 204, and these hold the pre-form in a cuboid shape when it is hinged to bring these rectangles to abut at their neighbouring edges. In this state, the pre-form support frame and reinforcing material can be over-moulded in a further mould tool.

However, with reference to FIG. 20, in accordance with a particular aspect of the invention, it is preferably placed on a mandrel 210 and additional reinforcing fabric 211 is wound onto it. To reinforce the central rectangle, one or more layers 12 of fabric, rolled over and cut to the cruciform or other shape of the pre-form, can be laid onto the central rectangle and folded onto the other rectangles. Typically this can be done in the following sequence:

1. A complete turn of wound fabric 211
2. A cruciform sheet 212 laid on, with tabs 213 laid over the wound fabric
3. A further turn of wound fabric
4. A further cruciform sheet
5. A final turn of wound fabric.

The mandrel is then withdrawn and the reinforced pre-mould is placed in an injection mould tool 214 as shown in FIG. 22 with or without the same or another mandrel and over-moulding material is injected to permeate the entirety of the reinforcing fabric and cover the limbs of the pre-form.

It will be appreciated that in like manner to that described for the first embodiment, flanges can be provided at the mouth of the casing.

In a further embodiment shown in FIGS. 23 to 28, the product is a tapered casing 301 open at both ends 321, 322, with flanges 323, 324. Its pre-form has eight trapezium shaped portions 325 analogous to the rectangles of the casing 201. The trapezium portions are hinged edge to adjacent edge. When wrapped around, the outside edges 326 abut and are provided with interlocking formations 327. Each trapezium portion has flange portions 328 at opposite ends. Whilst the pre-form could be wrapped with more reinforcing fabric and removed from a mandrel there is a risk of collapse inwards. For this reason, a solid former 329 is used. The limbs of the pre-form support structure are thin enough to flex and conform to the shape of the former, with the flange portions at the large diameter end of the cone attached only centrally to their trapezium portions. The solid former 329 is provided with quick release (quarter-turn) collars 330 against which the flange pre-forms lie. In wrapping of the trapezoidal portions with reinforcing fabric 331, bands 332 of elastomerically woven reinforcement can be partially captivated adjacent the wrapping and partially laid against the flange pre-forms 328. The casing 301 being tapered, the wrapping can be of elastomerically woven reinforcement fibre. To secure the flange pre-forms 328 in place, a further pre-form in the form of a split ring 333 with hinged tabs 334 can be laid against the flange part 335 of the bands, with the tabs held by the wound reinforcement.

Referring to FIG. 26 the wound reinforcement is placed in a two part mould 337,338, locating the former via end spigots 339 located in complementary recesses 340 in the mould parts. The split ring pre-form holds the flange reinforcement against collapse on mould closure. The mould parts have advanceable pins 341, which locate in and pass through the collars 323, 324, piercing the flange reinforcing fabric and passing into recesses 342 in the mould parts on the inside of the flanges.

On injection of polymer to permeate thoroughly the reinforcement and fill the mould cavity, the product is formed to finished dimensions with bolt holes formed that the piercing pins.

Referring to FIG. 28, where the tapered casing is to carry a shaft journalled in a bearing at its small end, as shown in outline in FIG. 27, the pre-form can be provided with a closure pre-form 343 having a central aperture into which is pre-moulded a bearing ring 344. To reinforce the ring within the end of the tapered casing, the former is modified to have a shoulder 345 sized to receive the bearing ring. A number of annular pieces of reinforcing fabric 346 are placed on both sides of the ring and located between the end face 347 of the former and the quarter turn collar 348. In this way, in addition to the previously described flange forming features, the ring is integrated into the flange on second stage moulding.

Where a mechanism requires a shaft to extend from a side of a casing 351, as shown in FIGS. 29 to 31, a bearing ring can be pre-moulded into one or more of the pre-mould portions such as the rectangular portions above. For instance where two such bearing rings 352, 353 are provided in opposite casing sides, the reinforcing fabric can be pushed aside with tapered spiked rod, or punched with corresponding apertures 354, and the hole reinforced with pre woven fabric ‘washers’ which register with the rings as the fabric is wound. The rings are located on spring-loaded bosses 355 on the former. In this product, a number of other features are shown which will now be described.

The former supports pointed, threaded, headed studs 356 on its end face, which also supports a central bearing ring 357. Both the studs and the bearing ring become moulded into the casing. The studs 356 are arranged at equal spacing and equal radius around the ring 357. First square pieces 358 of reinforcing fabric are pushed onto the studs 356. Then the pre-form, which has moulded rings 359 at the positions of the studs is applied and then final square pieces 360 are added.

The face 361 of the casing to have the central bearing ring is to be stepped 362. For this an annular piece 363 of bulky fabric is added around the ring.

A collar 364 is placed on a spigot 365 of the former. It locates on the central ring and receives the studs 356. To keep them free of polymer to be injected, when the wound pre-form is place in the final injection mould, shafts 366 carried on the collar 364 having blind, threaded end bores are engaged on the studs.

Also in the mould tool, rods 367 are passed through a flange 368 on the former at the open end of the casing.

The mould tool has spigots 369 advanceable into the bearing rings 352,353 from the side opposite from the bosses 355. Should the rings be slightly mis-positioned in the wrapped pre-mould, the spigots correctly position them with the pre-mould not being rigid. The bosses in the pre-mould are displaced and held latched in so that the product can be removed from the former after moulding.

Turning on to FIG. 32, an assembly of mouldings in accordance with a further embodiment of the invention is shown. A short moulding 401 such as the tapered casing 301 is assembled to a rectangular moulding 402 such as the casing 351, with the two being fastened by nuts 403 on studs 404 moulded into the rectangular moulding. The latter is moulded with a boss 405, which registers in the orifice 406 of the short casing. The combined mouldings form a differential casing. Bearings 409 and 410 are assembled into the support rings 407 & 408 for a pinion shaft 411 not found and a crown wheel and differential gear assembly 412. A closure moulding 413 is bolted to the back of the moulding 402. It is dished 414 and provided with wings 415 having flanges 416. Apertures 417 for mounting bushes (not shown) are provided. This moulding can be produced in like manner to the product 101. A further similar carrier moulding 418 having apertures 419 is assembled to the front of the moulding 401. These two mouldings support the differential casing at the four spaced apertures in a manner to react propeller shaft and half shaft torque. Although the moulding 413 is shown plain, it can be ribbed for heat dissipation.

In the embodiments described above, the hinges generally have the reinforcing fibres extending through them, with the fibres being overmoulded with the plastics material which forms the pre-form. Referring to FIG. 33, a hinge forming part of a pre-form support frame of a product according to another embodiment, which is otherwise similar to the embodiment of FIGS. 1 to 10, also comprises the reinforcing fibres 510 which extend through the two sections 512, 514 of the support frame 512 which are joined by the hinge, as well as though the hinge 516. The plastics material forming the support frame 512 is flexible, and the hinge 516 is formed by a narrowing in the thickness of the plastics material between the two thicker frame sections 512, 514.

Referring to FIG. 34, in a further modification, the hinge 616 is formed purely by the reinforcing fibres 610, so that the two frame sections 612, 614 are formed of separate pieces of the plastics material, which can therefore be rigid. This is achieved by arranging the moulding tool in which the pre-form is moulded to so that it prevents the flow of any of the plastics into the area of the reinforcing material which is to form the hinge.

Referring to FIG. 35, in a further modification, the hinge 716 is formed of a thin region of the moulded plastics material, and the reinforcing material extends through the frame sections 712, 714 and across the gap between them, but rather than extending through the hinge, the reinforcing fibres extend generally parallel to the hinge, but loosely so that, when the frame sections are laid flat as originally moulded, there is a loose curved loop section of the reinforcing fibres between the two frame sections 712, 714. When the hinge is bent, with the fibres 710 on the outside of the hinge, the fibres become taught at a particular angle of bending and restrict further bending of the hinge.

Referring to FIG. 36, in a further modification, the hinge 816 and reinforcing fibres 810 are arranged between the moulded frame sections 812, 814 in a similar way to those of FIG. 35, but in this case, stop surfaces 818, 820 are provided on the ends of the frame sections on the inside of the hinge 816. Referring to FIG. 37, the length of the free portion of the reinforcing fibres 810, i.e. the part of the fibres between the two frame sections which is not enclosed in the moulded plastics material, is controlled by wrapping the fibres around a movable tool insert in the form of a rod 822. One side of this rod 822, when it is in place, forms one side of the part of the mould cavity in which the hinge is moulded, and the other side has the fibres wrapped around it so that they curve out of the general plane of the support frame sections 812, 814. The length of the curved outer side of the rod 822 determines the length of the free portion of the fibres 810. The rod can be withdrawn as shown in FIG. 37 when the pre-mould support frame had been moulded, so that the support frame with the reinforcing fibres can be removed from the mould.

The stop surfaces 818, 820 are arranged to come into contact with each other at a predetermined angle of bending of the hinge so as to restrict or prevent further bending, and this angle is the same angle at which the reinforcing fibres 810 become taught and also act to restrict further bending, as shown in FIG. 38.

Referring to FIGS. 39 and 40, in a further modification to the embodiment of FIGS. 36 to 38, an insert 824 can be inserted between the plastics hinge and the free portion of the reinforcing fibres. The insert 824 can be formed of metal, plastics or a pack of fibres. The insert 814 can serve a number of purposes, for example it can be part of a fixing for attaching another article to the finished moulded product, or it can be purely for stiffening.

Referring to FIG. 41, in a further modification, the stop surfaces on the pre-form sections 912, 914 comprise a group of mounds 918 on one of the sections 912, and a flat surface 920 on the other of the sections 914. In this case the hinge is formed by a free length of the reinforcing fibres 910. When the hinge is folded to an angle such that the two pre-form sections 912, 914 are perpendicular to each other the mounds 918 come into contact with the flat surface 920, and the free length of reinforcing fibre 910 becomes taught, so further folding is prevented. The mounds 918 also act as spacers to keep the two sections 912. 914 spaced from each other so that, in the second moulding phase, the over-moulding plastics can flow between them. If the free length of fibre 910 is just shorter than the height of the mounds 918, one of the mounds 918 closest to the free length of fibre 910 will come into contact with the surface 920 first and the free length of fibre 910 will become taut before the other mound 918, further from the fibre, reaches the surface 920. Then, further folding will further tension the fibre 910 so that, when both of the mounds 910 are in contact with the surface 920, the fibre 910 will be held in tension. It will be appreciated that, while only a short part of the fibre 910 is shown as being free of the pre-mould, much longer sections of the fibre could extend along the outside of the pre-mould, either in contact with it or raised above its surface by spacers, and be tensioned in the same way. When the second moulding step is preformed this encases the tensioned fibres within the moulded body material which adds rigidity and strength to the product.

Referring to FIG. 42, in a further modification, the spacer mounds 918 are replaced by damming ridges 930 which extend along the length of the hinge. These serve as stops to limit folding of the hinge as in the embodiment of FIG. 41, but rather than allowing the over-moulded plastics to flow between the sections of the pre-form, these ridges act as dams which block the flow of the plastics material through the gaps between the pre-form sections. When the pre-mould is folded so that the sections surround a cavity, the ridges 930 will be inside, and spaced from, the reinforcing fibres that form the hinge. Therefore when over-moulding material is applied to the outside of the structure, it will cover the free unsupported parts of the fibres and pass between the sections as far as the ridges 930, but then be blocked from moving further into the interior of the structure. The fibres in this modification can be tensioned in the same ways as that of FIG. 41. The tops of the dams can each be welded, for example by laser welding, to the adjacent pre-form section against which they abut to seal the interior of the product.

Referring to FIG. 43, in a further modification, the structure is the same as that of FIG. 42, but in this case a series of fibre supports 940 are provided on each of the pre-form sections. These fibre supports 940 project from the side of each of the sections, on the side that forms the outside of the structure when the pre-form is folded, as shown in FIGS. 44 and 45. After the pre-form has been folded, further reinforcing fibres 942 can be wrapped around the folded structure, so that they are supported on the supports 940. The supports 940 are arranged to support the fibres such that they are spaced from the outer surfaces of the pre-form sections. When the second moulding step is performed, the over-moulding plastics materials fully encases the outer layer of reinforcing fibres as well as the exposed parts of the inner reinforcing fibres that are not embedded within the pre-form and which either form the hinges or extend across the openings in the pre-form. In a further modification, rather than being wrapped round the pre-mould after folding, the outer fibres can be attached to the supports 940 prior to folding. Then on folding the distance between the supports on opposite sides of each hinge will increase, so the fibres can be further tensioned by the folding, prior to over-moulding.

The supports 940 can be all the same height, or they can be in groups each group being of a different height, so that the fibres are held at different distances from the surface of the pre-form. This provides a plurality of layers of fibres each of which will be wetted in the over-moulding step.

In a further modification, in the embodiment of FIGS. 43 to 45, no fibres are moulded into the pre-mould, and the hinges are live hinges formed purely of plastics material. The only reinforcing fibre is then that which is wrapped round, or applied to, the outside of the pre-mould, which is then moulded in during the over-moulding.

Referring to FIGS. 46 to 48, in a further modification, the reinforcing fibres 950 in each section or panel 952 of the pre-form are separate, so the fibres do not extend between adjacent panels as they do in the embodiments described above. In this case the hinges 954 between the panels are formed by interlocking formations 956, 958 formed on the edges of the support frames of the panels.

Referring to FIGS. 49 to 52, in a further embodiment of the invention during moulding of a panel section 960 of a pre-mould, which also comprises a support frame 961 with reinforcing fibres 962 moulded across it, a removable mould insert or core 963 with two prongs 964 is located so that the prongs 964 extend through the mould cavity in which one of the sections of the pre-form is moulded, and through the stack or bundle of reinforcing fibres where they extend through that cavity. The result of this is that the fibres are compressed around the prongs, and in the pre-moulding step a space 965 is left within the moulded-in fibres were each of the prongs 964 is. After the pre-moulding step the prongs 964 are withdrawn leaving that space open. This can be used to locate some form of insert in the space for the second moulding stage, or the space can be left open to be filled during the second moulding stage.

Referring to FIGS. 53 to 56, in a further embodiment of the invention during moulding of a panel section 970 of a pre-mould, which also comprises a support frame 971 with reinforcing fibres 972 moulded across it, a removable mould insert or core 973 with a single bar 974 is located so that the bar 974 extends through the mould cavity in which one of the sections of the pre-form is moulded on one side of the layer of reinforcing fibres 972 and also into a part of one side of the region of the cavity where the fibres 972 are located. The result of this is that the fibres are compressed to the other side of that region of the cavity forming a compacted region of fibres, and in the pre-moulding step they are moulded into that compacted condition at that point. After the pre-moulding step the bar 974 is withdrawn leaving the compacted region of fibres, which will remain in the second moulding step. This can be used to form a strengthened region of the final product.

It will be appreciated that the mould tool can be modified in various further ways to manipulate the reinforcing fibres prior to, and during, the second moulding step. Therefore in general, automatic fibre placement can be used to shape the fibres for the mould, preferably without human intervention, i.e. very quickly. This can be achieved, for example, by:

designing and specifying the correct width/warp/weft/multi axial layers of fabrics;

feeding them over mould in multiple correct angles;

using robotic arms to ‘push-pull and snag’ fabric onto predetermined pins in the pre-mould (the hollow they produce can later be filled during second moulding stage);

compression of the fabric by the descending top moulding tool.

Elasticated fabric or other fibres can be used to do part of the work. Also woven shaped fabric such as spiral ribbon or webs can assist further. Folding of the preform can be designed to further shape the fabric ready for over moulding, for example as described in some of the embodiments above. The fibres can be pulled or pushed into the shape of the tool as tool closes. The fibres can be ‘snagged’ by pins around the tool surface and edge, as described above. The same or different pins and hoops can be used to position additional layers of fabric reinforcement or layers of a skeletal pre-mould.

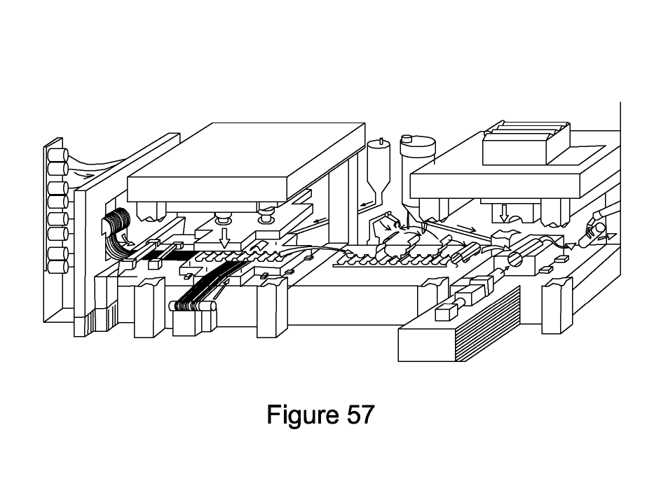

Referring to FIG. 57, a manufacturing system for manufacturing the systems described above includes a pre-mould station in which the fibres are robotically placed in the pre-moulding tool, which is then closed and the pre-mould formed, a shaping station in which the parts of the pre-mould are moved into the desired position in which they are to be in the final product, and any further reinforcing fibres are added to the product, and a second moulding station in which the second moulding stage is performed. It will be appreciated that this system can be modified so that the relevant station is arranged to perform the steps required to make any of the embodiments described above in a fully automated manner.

1. A method of forming a moulded product of fibre reinforced body material, the method comprising the steps of:
moulding a support that defines openings therein such that reinforcing fibres extend across the openings and into the support; and
moulding body material around the reinforcing fibres in the openings.

2. The method according to claim 1 wherein the support comprises a plurality of sections which are movable relative to each other, and the method comprises positioning the sections relative to each other before the moulding of the body material.

3. The method according to claim 2 wherein the support comprises a hinge arranged to join the sections together so that the support can be folded at the hinge.

4. The method according to claim 3 wherein the support is folded at the hinge prior to the moulding of the body material.

5. The method according to claim 3 wherein the reinforcing fibres extend between the sections so as at least partly to form the hinge.

6. The method according to claim 3 wherein the step of moulding the support includes moulding material so as at least partly to form the hinge.

7. The method according to claim 6 wherein the reinforcing fibres extend between the sections so as at least partly to form the hinge, and the step of moulding material to at least partly form the hinge comprises moulding material over a part of the reinforcing fibres to form the hinge.

8. The method according to claim 2 wherein the sections comprise locating stops arranged to locate the sections in a desired relative position.

9. The method according to claim 8 wherein the locating stops comprise a part of the reinforcing fibres.

10. The method according to claim 8 wherein the locating stops comprise stop surfaces on the sections arranged to abut against one another to locate the sections.

11. The method according to claim 1 wherein the support comprises fibre supports and the method comprises supporting further reinforcing fibres on the fibre supports prior to moulding the body material.

12. The method according to claim 11 wherein the support comprises a plurality of sections which are movable relative to each other, and the method comprises positioning the sections relative to each other before the moulding of the body material, and wherein the further reinforcing fibres are wrapped around the support when the sections are positioned relative to each other.

13. The method according to claim 1 wherein the reinforcing fibres are held in tension during the moulding of the support, and the support is moulded around the reinforcing fibres so that the moulded support holds the reinforcing fibres in tension.

14. The method according to claim 13 wherein the support is moulded in a mould tool that comprises tensioners arranged to tension the reinforcing fibres on closing of the mould tool.

15. The method according to claim 1 wherein the support is moulded in a tool having a movable part and the method comprises placing the reinforcing fibres in the tool, and moving said part to move the reinforcing fibres prior to moulding the support.

16. A method of forming a moulded product of fibre reinforced body material, the method comprising the steps of: providing a moulded support having two sections joined to each other by at least one hinge and a reinforcing fibre extending between the two sections, folding the sections relative to each other thereby to tension the reinforcing fibre, and moulding body material around the reinforcing fibre.

17. The method according to claim 16 wherein the support comprises spacers arranged to space the reinforcing fibre from the surface of the support so that the body material can completely enclose a length of the reinforcing fibre.

18. The method according to claim 17 wherein two of the spacers are arranged to move away from each other on folding of the sections thereby to tension the reinforcing fibre.

19. A method of forming a moulded product of fibre reinforced body material, the method comprising the steps of: providing a moulded support and reinforcing fibres supported by the support such that at least a part of each of the reinforcing fibres is clear of the support, and moulding body material around the reinforcing fibres so that the body material encloses said parts.

20. The method according to claim 19 wherein the support is arranged to support the reinforcing fibres at either side of said parts.

21-22. (canceled)
